(19) United States
(12) Patent Application Publication
(10) Pub. No.: US 2021/0392938 A1
(43) Pub. Date: Dec. 23, 2021

(54) DEVICE FOR ROASTING BEANS

(71) Applicant: Sandbox Smart Technology Co., Ltd., New Taipei City (TW)

(72) Inventors: WU-HUNG YANG, New Taipei (TW); HSIN-CHU LEE, New Taipei (TW); CHIH-HUNG LIU, New Taipei (TW)

(21) Appl. No.: 16/931,684

(22) Filed: Jul. 17, 2020

(30) Foreign Application Priority Data
Jun. 19, 2020 (TW) 109120931

(51) Int. Cl. A23N 12/10

(52) U.S. Cl. CPC A23N 12/10

(57) ABSTRACT

A device for roasting beans which is significantly easier to install and place in a bean-roasting machine includes a chassis, a bean roasting tube, and a driving member. The chassis defines an accommodating cavity and a receiving hole communicating with the accommodating cavity. The bean roasting tube includes a rotating member and a chamber. The rotating member is detachably connected to the chassis. The chamber includes a first end plate, a second end plate opposite to the first end plate, and a bearing piece fixedly connected between the first end plate and the second end plate. The second end plate faces the receiving hole and is rotatably connected to the rotating member. The driving member is fixed to the first end plate and movable to drive the chamber to rotate in the accommodating cavity.

### FIELD

The subject matter herein generally relates to a device for roasting beans.

### BACKGROUND

Bean roasting devices include cases and bean roasting tubes disposed in the cases. The case includes a door and two walls arranged on both sides of the box door. The two walls have fixing pins and fixing holes for fixing two opposite ends of the bean roasting tube. When the door is opened to install the bean roasting tube, the bean roasting tube is first placed horizontally in the chassis, and then tilted so that one end of the bean roasting tube is connected to one of the two walls, and the other end of the bean roasting tube is adjusted to connect with the other one of the two walls. During the above described installation process, the bean roasting tube crosses between the two side walls. Due to the blocking of the bean roasting tube, it is difficult to determine the position of the fixing pin and the fixing hole, thus installing the bean roasting tubes in the case is unnecessarily time-consuming.

### BRIEF DESCRIPTION OF THE DRAWINGS

Implementations of the present technology will now be described, by way of embodiments with reference to the attached figures.

FIG. 1 is an isometric view of a device for roasting beans.

FIG. 2 is a partly exploded isometric view of the device in FIG. 1 without a housing.

FIG. 3 is similar to FIG. 2, but viewed from another viewpoint.

FIG. 4 is an exploded isometric view of a bean roasting tube.

FIG. 5 is cross-sectional view along line V-V of FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to show details and features of the present disclosure better. The disclosure is by way of embodiments and not by way of limitation in the figures of the accompanying drawings, in which like references indicate similar elements. It should be noted that references to “an” or “one” embodiment in this disclosure are not necessarily to the same embodiment, and such references mean “at least one.”

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like. The references “a plurality of” and “a number of” mean “at least two.”

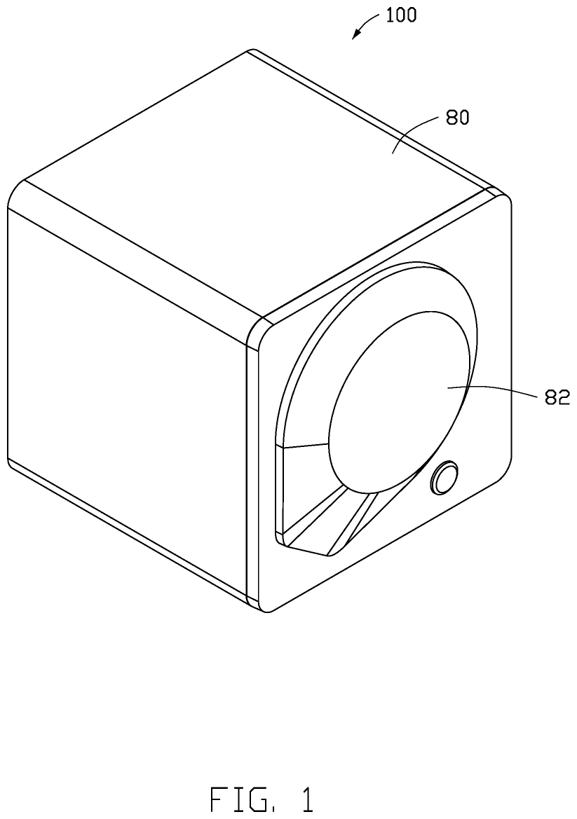

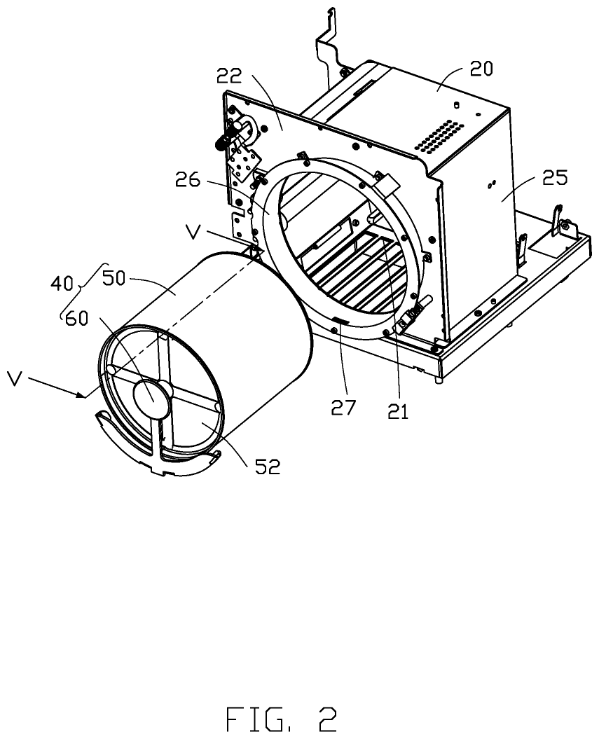

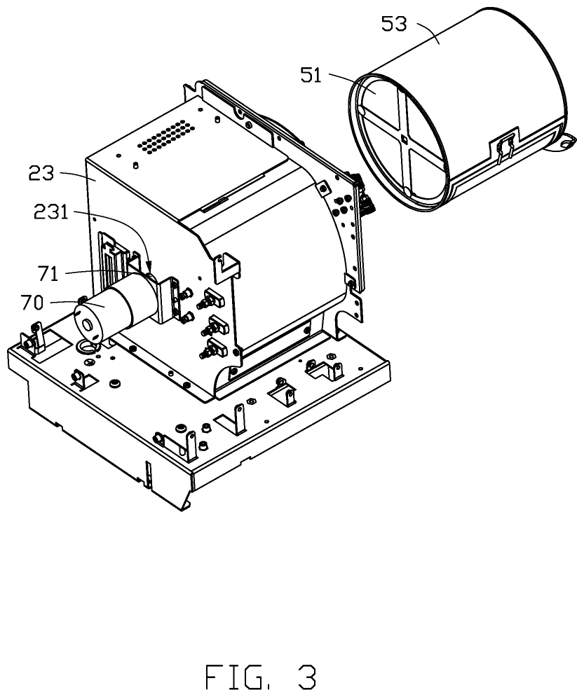

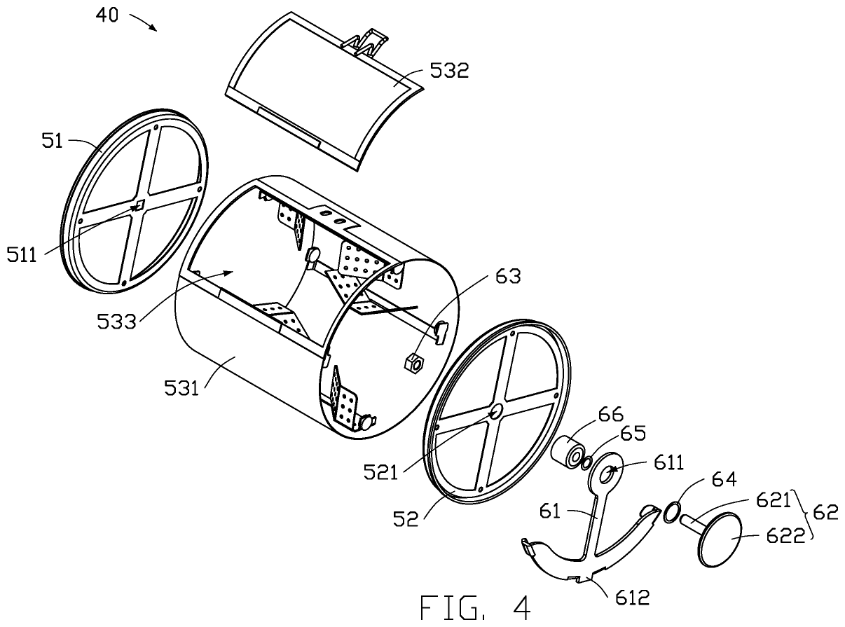

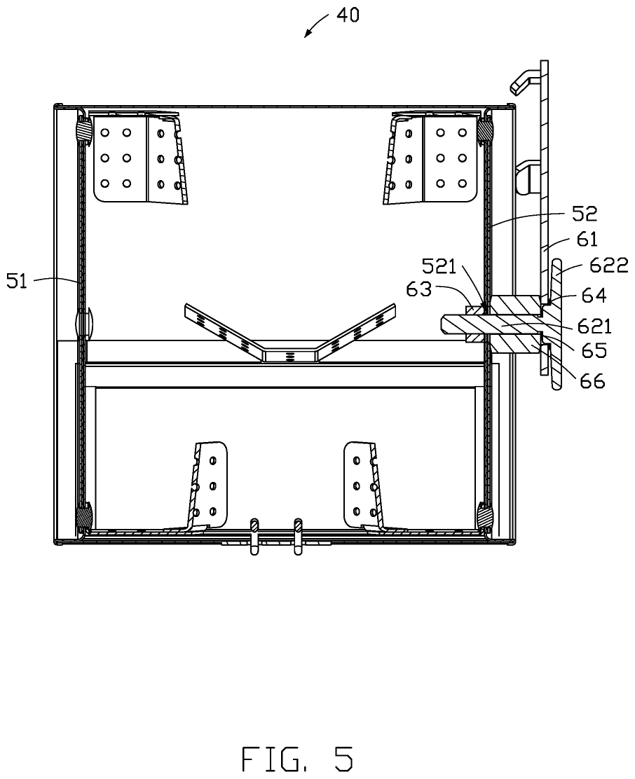

Referring to FIGS. 1-5, the present application provides a device 100 for roasting beans. The device 100 includes a chassis 20, a bean roasting tube 40, a driving member 70, a heating member (not shown), and a housing 80. The chassis 20 defines an accommodating cavity 21. The bean roasting tube 40 is fixed to rotate in the accommodating cavity 21, and turns over the beans within the bean roasting tube 40. The driving member 70 is connected to the bean roasting tube 40 for driving the bean roasting tube 40 to rotate in the accommodating cavity 21. The heating member is fixed in the accommodating cavity 21 to dry and roast the beans in the bean roasting tube 40 when the bean roasting tube 40 rotates in the chassis 20. The housing 80 surrounds to define a receiving cavity (not shown), and an opening (not shown) on one side communicating with the accommodating cavity 21. The receiving cavity is configured to accommodate the chassis 20, the bean roasting tube 40, the driving member 70, and the heating member. The opening is opened to allow placement of the bean roasting tube 40, and the opening is closed to dry the beans in the bean roasting tube 40. In an embodiment, a rotating door 82 is installed at the opening. When the rotating door 82 rotates away from the chassis 20, the opening is opened, and when the rotating door 82 rotates to the chassis 20, the opening is closed.

The chassis 20 includes a front panel 22, a rear panel 23, and a side panel 25 connected between the front panel 22 and the rear panel 23. The front panel 22, the rear panel 23, and the side panel 25 surround and define the accommodating cavity 21. The front panel 22 defines a receiving hole 26 communicating with the accommodating cavity 21 and the opening. The front panel 22 is provided with a fixing portion 27 at the receiving hole 26 to connect with the bean roasting tube 40. In an embodiment, the fixing portion 27 is a slot. The rear panel 23 defines a through hole 231.

The driving member 70 is disposed outside the chassis 20. The driving member 70 includes a rotatable driving portion 71. One end of the rotatable driving portion 71 passes through the through hole 231 to be received in the accommodating cavity 21 and connect to the bean roasting tube 40. The rotatable driving portion 71 rotates the bean roasting tube 40. In an embodiment, the driving member 70 is a motor, and the rotatable driving portion 71 is a driving shaft.

The bean roasting tube 40 includes a chamber 50 and a rotating member 60. The chamber 50 includes a first end plate 51, a second end plate 52 opposite to the first end plate 51, and a bearing piece 53 fixedly connected between the first end plate 51 and the second end plate 52. The first end plate 51 defines a fixing hole 511. The fixing hole 511 is configured to fix the rotatable driving portion 71 to fix the chamber 50 to the driving member 70. The second end plate 52 faces the receiving hole 26 and defines a rotating hole 521. The rotating hole 521 is configured to connect with the rotating member 60 so that the chamber 50 rotates with the rotatable driving portion 71. In an embodiment, the fixing hole 511 is a rectangular hole, and the driving shaft is a rectangular shaft matching with the rectangular hole. The first end plate 51 and the second end plate 52 are disk-shaped, and the bearing piece 53 is cylindrical. In another embodiment, the first end plate 51 and the second end plate 52 can be square in shape, and the bearing piece 53 can be a tetrahedron. It can be understood that the first end plate 51, the second end plate 52, and the bearing piece 53 can be other shapes, as long as they will carry and contain beans. The bearing piece 53 includes a curved first carrying piece 531 and a curved second carrying piece 532. The first carrying piece 531 defines a notch 533. The second carrying piece 532 is disposed at the notch 533 to open and close the notch 533. When the notch 533 is opened, the beans can be placed in the chamber 50. When the beans are placed in the chamber 50, the second carrying piece 532 closes the notch 533 and is fixed to the first carrying piece 531.

The rotating member 60 is rotatably connected to the second end plate 52 and detachably connected to the fixing portion 27. After the rotating member 60 is fixedly connected to the fixing portion 27, the bean roasting tube 40 is rotatable relative to the rotating member 60. In an embodiment, the rotating member 60 includes a connecting member 61, a positioning member 62, and a fixing member 63. The connecting member 61 is disposed on a side of the second end plate 52 away from the first end plate 51. The connecting member 61 defines a through hole 611 and has a connecting portion 612 at an edge of the connecting member 61. The connecting portion 612 is detachably connected to the fixing portion 27. In an embodiment, the connecting portion 612 is a buckle, and the buckle is detachably locked in a slot on the front panel 22 to connect the connecting member 61 to the front panel 22. The positioning member 62 includes a rotating shaft 621 and a blocking portion 622 fixed to one end of the rotating shaft 621. An end of the rotating shaft 621 away from the blocking portion 622 passes through the through hole 611 and the rotating hole 521 and is positioned on a side of the second end plate 52 close to the first end plate 51. The blocking portion 622 is positioned on a side of the connecting member 61 away from the second end plate 52. The fixing member 63 is positioned on the side of the second end plate 52 close to the first end plate 51, and fixed to the rotating shaft 621 to rotatably connect the chamber 50 to the rotating member 60. Because the chamber 50 is rotatably connected to the rotating member 60, when the driving member 70 rotates the rotatable driving portion 71, the chamber 50 can rotate in the accommodating cavity 21, thereby drying and roasting the beans positioned in the chamber 50.

The rotating member 60 further includes a first lubricating member 64 and a second lubricating member 65, which reduce vibration and noise when the bean roasting tube 40 rotates. The first lubricating member 64 and the second lubricating member 65 are made of TEFLON. The first lubricating member 64 is sleeved on the rotating shaft 621 and positioned between the blocking portion 622 and the connecting member 61. The second lubricating member 65 is sleeved on the rotating shaft 621 and positioned between the connecting member 61 and the second end plate 52. In an embodiment, the rotating member 60 further includes a sleeve 66. The sleeve 66 is positioned between the second lubricating member 65 and the second end plate 52, and sleeved on the rotating shaft 621, so that the chamber 50 rotates in a stable manner around the rotating shaft 621.

When installing the bean roasting tube 40 in the chassis 20, the opening is opened, the first end plate 51 faces the opening, and passes through the opening and the receiving hole 26 to be fixed to the driving member 70. At this time, the second end plate 52 faces the receiving hole 26, and then the rotating member 60 is rotated to connect the rotating member 60 to the chassis 20. Thereby the bean roasting tube 40 is installed in the chassis 20. Then the opening is closed, the beans in the bean roasting tube 40 can be roasted by the device 100. A conventional bean roasting tube cross-positioned in the chassis is installed much less conveniently, and over a longer time.

The embodiments shown and described above are only examples. Therefore, many commonly-known features and details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will, therefore, be appreciated that the embodiments described above may be modified within the scope of the claims.

What is claimed is:

1. A device for roasting beans comprising:
a chassis defining an accommodating cavity and a receiving hole communicating with the accommodating cavity;
a bean roasting tube comprising:
a rotating member detachably connected to the chassis; and
a chamber comprising a first end plate, a second end plate opposite to the first end plate, and a bearing piece fixedly connected between the first end plate and the second end plate, the second end plate facing the receiving hole and rotatably connected to the rotating member;
a driving member fixed to the first end plate and being movable to drive the chamber to rotate in the accommodating cavity.

2. The device of claim 1, wherein the second end plate defines a rotating hole, the rotating member is rotatably received in the rotating hole.

3. The device of claim 2, wherein the rotating member comprises a connecting member, a positioning member, and a fixing member, the connecting member is disposed on a side of the second end plate away from the first end plate, the connecting member defines a through hole, the positioning member comprises a rotating shaft and a blocking portion fixed to one end of the rotating shaft, the rotating shaft passes through the through hole and the rotating hole and is positioned on a side of the second end plate close to the first end plate, the fixing member is positioned on the side of the second end plate close to the first end plate and fixed to the rotating shaft.

4. The device of claim 3, wherein the chassis defines a fixing portion at the receiving hole, the connecting member includes a connecting portion at an edge of the connecting member, the connecting portion is detachably locked to the fixing portion.

5. The device of claim 3, wherein the rotating member further comprises a first lubricating member, the first lubricating member is sleeved on the rotating shaft and positioned between the blocking portion and the connecting member.

6. The device of claim 3, wherein the rotating member further comprises a second lubricating member, the second lubricating member is sleeved on the rotating shaft and positioned between the connecting member and the second end plate.

7. The device of claim 1, wherein the first end plate defines a fixing hole, the driving member is a motor, the motor comprises a rotatable driving portion, the rotatable driving portion is fixed in the fixing hole.

8. The device of claim 7, wherein the chassis comprises a front panel, a rear panel, and a side panel connected between the front panel and the rear panel, the accommodating cavity is positioned between the front panel and the rear panel, the receiving hole is defined on the front panel, the rear panel defines a through hole, the rotatable driving portion passes through the though hole to be fixed in the fixing hole.

9. The device of claim 1, wherein the bearing piece comprises a first carrying piece and a second carrying piece, the first carrying piece defines a notch, the second carrying piece is disposed at the notch to open and close the notch.

10. A bean roasting device comprising:
a chassis defining an accommodating cavity and a receiving hole communicating with the accommodating cavity;
a bean roasting tube comprising:
a rotating member detachably connected to the chassis; and
a chamber comprising a first end plate, a second end plate opposite to the first end plate, and a bearing piece fixedly connected between the first end plate and the second end plate, the second end plate passing through the receiving hole to be received in the accommodating cavity and rotatably connected to the rotating member;
a driving member fixed to the first end plate and being rotatable to drive the chamber to rotate in the accommodating cavity.

11. The bean roasting device of claim 10, wherein the second end plate defines a rotating hole, the rotating member is rotatably received in the rotating hole.

12. The bean roasting device of claim 11, wherein the rotating member comprises a connecting member, a positioning member, and a fixing member, the connecting member is disposed on a side of the second end plate away from the first end plate, the connecting member defines a through hole, the positioning member comprises a rotating shaft and a blocking portion fixed to one end of the rotating shaft, the rotating shaft passes through the through hole and the rotating hole and is positioned on a side of the second end plate close to the first end plate, the fixing member is positioned on the side of the second end plate close to the first end plate and fixed to the rotating shaft.

13. The bean roasting device of claim 12, wherein the chassis defines a fixing portion at the receiving hole, the connecting member includes a connecting portion at an edge of the connecting member, the connecting portion is detachably locked to the fixing portion.

14. The bean roasting device of claim 12, wherein the rotating member further comprises a first lubricating member, the first lubricating member is sleeved on the rotating shaft and positioned between the blocking portion and the connecting member.

15. The bean roasting device of claim 12, wherein the rotating member further comprises a second lubricating member, the second lubricating member is sleeved on the rotating shaft and positioned between the connecting member and the second end plate.

16. The bean roasting device of claim 10, wherein the first end plate defines a fixing hole, the driving member is a motor, the motor comprises a rotatable driving portion, the rotatable driving portion is fixed in the fixing hole.

17. The bean roasting device of claim 16, wherein the chassis comprises a front panel, a rear panel, and a side panel connected between the front panel and the rear panel, the accommodating cavity is positioned between the front panel and the rear panel, the receiving hole is defined on the front panel, the rear panel defines a through hole, the rotatable driving portion passes through the though hole to be fixed in the fixing hole.

18. The bean roasting device of claim 11, wherein the bearing piece comprises a first carrying piece and a second carrying piece, the first carrying piece defines a notch, the second carrying piece is disposed at the notch to open and close the notch.
